(19) United States
(12) Patent Application Publication
(10) Pub. No.: US 2021/0044192 A1
(43) Pub. Date: Feb. 11, 2021

(54) TRANSVERSE FLUX RELUCTANCE MOTOR

(71) Applicants: thyssenkrupp Presta AG, Eschen (LI); thyssenkrupp AG, Essen (DE)

(72) Inventor: Robert GALEHR, Schaanwald (LI)

(73) Assignees: thyssenkrupp Presta AG, Eschen (LI); thyssenkrupp AG, Essen (DE)

(21) Appl. No.: 16/978,424

(22) PCT Filed: Mar. 27, 2019
(86) PCT No.: PCT/EP2019/057717

§ 371 Date: Sep. 4, 2020

(30) Foreign Application Priority Data
Mar. 29, 2018 (DE) 10 2018 107 613.4

(51) Int. Cl. H02K 37/04; H02K 1/30; H02K 1/16; H02K 3/02; H02K 3/12; H02K 3/48; H02K 3/28; H02K 21/14; H02K 15/02; H02K 11/33; H02P 27/06; H02K 9/22; B62D 6/00; B62D 5/04; B62D 5/00

(52) U.S. Cl. CPC H02K 37/04; H02K 2201/12; H02K 1/165; H02K 3/02; H02K 3/12; H02K 3/48; H02K 3/28; H02K 21/145; H02K 15/026; H02K 11/33; H02P 27/06; H02K 9/22; B62D 6/008; B62D 5/046; B62D 5/006; H02K 1/30

(57) ABSTRACT

A reluctance motor with a rotor which rotates about a longitudinal axis and an individual stator. The rotor has on a surface close to the stator a toothing, and the stator has on the surface close to the rotor a corresponding toothing, the teeth of which extend longitudinally. The stator has at least two cavities arranged successively in the longitudinal direction each configured to receive a toroidal coil which can be energized. The windings of the toroidal coils are wound concentrically around the longitudinal axis. The stator is penetrated on the side close to the rotor to form a respective air gap toward the cavities. The air gap is aligned in a circular-cylindrical manner and concentrically to the longitudinal axis and has a constant height longitudinally which is smaller than the extent of the toroidal coil in the direction of the longitudinal axis.

The present invention relates to a reluctance motor with the features of the preamble of claim 1 and a method for assembling a reluctance motor with the features of the preamble of claim 27.

Electric motors are used in many sectors in motor vehicle steering systems. For example, in conventional electromechanical steering systems, they can apply steering power assistance and in steer-by-wire steering systems, where there is no direct mechanical coupling between the steering wheel and the steering linkage, provide the driver with a steering sensation. Electric motors for adjustment of the steering column are furthermore known.

In order to achieve good slow rotational efficiency in the case of slowly rotating and high-torque motors, it is desirable to use as many stator poles and rotor poles as possible. However, this has been shown to be difficult since the coils and magnets cannot be constructed to be as small as desired and the costs for small coils and magnets are not acceptable.

It is the object of the present invention to indicate a structurally simple electric motor with high torque, preferably for a steering system, which has good functionality alongside a small installation space. It is furthermore an object of the invention to indicate an electric motor which can be used as a direct drive.

This object is achieved by a reluctance motor with the features of claim 1 and a method for assembling a reluctance motor with the features of claim 27. Advantageous further developments of the invention can be inferred from the subordinate claims.

A reluctance motor with a rotor which rotates about a longitudinal axis and an individual stator is accordingly provided, the rotor having on a surface close to the stator a toothing, and the stator having on a surface close to the rotor a corresponding toothing, the teeth of which extend in the direction of the longitudinal axis, the stator having at least two cavities arranged successively in the longitudinal direction for receiving in each case a toroidal coil which can be energized, the windings of the toroidal coils being wound concentrically around the longitudinal axis, and the stator being penetrated on the side close to the rotor for the formation of a respective air gap toward the cavities, and the air gap being aligned in a circular-cylindrical manner and concentrically to the longitudinal axis and having a constant height in the direction of the longitudinal axis which is smaller than the extent of the toroidal coil in the direction of the longitudinal axis.

The reluctance motor thus has according to the invention transverse reluctance machines, in the case of which the magnetic flux, in contrast e.g. to hybrid synchronous machines (HSM) or reluctance step motors with concentrated winding, does not run perpendicular, but rather parallel to the axis of rotation. The coil is therefore formed as a toroidal coil concentrically to the axis of rotation.

Transverse reluctance machines cannot be driven by a traditional magnetic rotational field (a rotational field which rotates in a plane with the axis of rotation). Transverse reluctance machines are therefore step motors which cannot in principle be controlled. Controllability can only be achieved by the linking of several such reluctance machines in the axial direction. The reluctance motor according to the invention has good functionality alongside a small space requirement.

The toothings of the rotor and of the stator preferably have a substantially uniform tooth pitch, i.e. it is, however, possible to omit an individual tooth and/or arrange a tooth portion offset by two, four or six teeth.

The surface of the stator close to the rotor preferably has grooves which form the toothing. The number of poles can thus be increased to an extreme degree, which leads to improved efficiency at low rotational speeds.

In one preferred embodiment, the stator has stator segments which surround in each case a toroidal coil and which are formed from two or three components. The stator is therefore formed from a few parts, which keeps the assembly costs low. It is advantageous here if the stator segments are formed from two components, the components being stator rings. These stator rings can have in each case a U-shaped profile with a circumferential annular groove and two limbs, the limbs of the stator rings extending in the direction of the longitudinal axis and being arranged concentrically thereto. The two stator rings of a stator segment are preferably aligned to one another so that the two circumferential annular grooves point into the center between the two stator rings and form the cavity for the toroidal coil. In this case, it is advantageous if the limbs of the stator rings are of different lengths, the stator rings lying against the front sides of the longer limbs and the air gap being formed between the front sides of the shorter limbs.

It can be provided that the rotor has magnets on the surface close to the stator.

The teeth of the rotor can extend in the direction of the longitudinal axis or be arranged in a manner skewed thereto.

A heat-conducting paste or heat-conducting adhesive is preferably incorporated in the cavity between toroidal coil and stator.

In order to simplify assembly, the windings of the toroidal coils are preferably surrounded by a polymer. A connector of a port of the toroidal coil can already be integrated in the polymer. The toroidal coil is preferably a separate pre-assembled component.

It is advantageous if the rotor is arranged exclusively inside or outside the stator.

In one embodiment, the toroidal coils can have two coil segments connected in series.

The reluctance motor preferably has a control unit, the toroidal coils being actuable by means of the control unit with pulse width modulation (PWM). It is advantageous here if the control unit has an inverter for energizing the toroidal coils.

For simplified mounting of the motor, the stator segments are secured via front plates in an axial interference fit assembly.

It can be provided here to fasten the control unit on and/or in one of the front plates. The front plate and a house of the inverter are preferably formed in one piece.

In one preferred embodiment, the toothings of the rotor and of the stator are produced using the sintering process. Magnetically active parts of the motor are therefore not composed of packaged sheet metal lamellas since the magnetic flux should not be inhibited in the longitudinal direction.

The teeth of two stator rings of a stator segment are preferably axially flush. The number of teeth in the circumferential direction is preferably greater than 30, in particular greater than 50.

A further, independent stator segment can be provided which serves as a reluctance brake.

There is provided a steer-by-wire steering system for motor vehicles comprising a steering controller which acts on the steered wheels and is electronically regulated as a function of a driver's steering desire, which steering controller acts by means of a steering gear on the steered wheels, and a feedback actuator which transmits feedback effects to a steering shaft connected to the steering wheel, the feedback actuator having a reluctance motor described above.

A steering system for motor vehicles comprising a reluctance motor described above as a direct drive is furthermore provided.

A method for assembling a reluctance motor described above with the following steps is furthermore provided:
providing an assembly pin which extends in the longitudinal direction and which ensures the relative alignment of the stator segments to one another,
placing a second front plate on a seat of the assembly pin,
placing the stator segments with toroidal coils arranged therebetween in series, successively on the assembly pin,
positioning a first front plate onto the last applied stator segment and connecting the two front plates by means of connecting screws.

Assembly is particularly simple as a result of the use of an assembly pin and the connection of the two front plates by means of connecting screws. Only a few tools are required, which reduces costs.

Spacers are preferably positioned between the stator segments onto the assembly pin.

The following further steps can be provided:
positioning a corrugated spring onto the second front plate onto the assembly pin;
extending stator pins connected to the assembly pin; The following further step is furthermore preferably provided:
placing a spacer onto the last applied stator ring and positioning a rolling bearing which sits in the first front plate.

In the case of one preferred embodiment, the method comprises the following steps:
generating a pretensioning on the first front plate before the two front plate are connected by means of connecting screws,
releasing the pretensioning and removing the assembly pin.

Preferred embodiments of the invention are explained in greater detail on the basis of the drawings. The same reference numbers are used for identical elements or elements with the same function in all the drawings. In the drawings:

FIG. 1: shows a schematic representation of a steer-by-wire steering system,

FIG. 2: shows a longitudinal section through a reluctance motor according to the invention,

FIG. 3: shows a schematic representation of an actuation unit of the reluctance motor according to the invention,

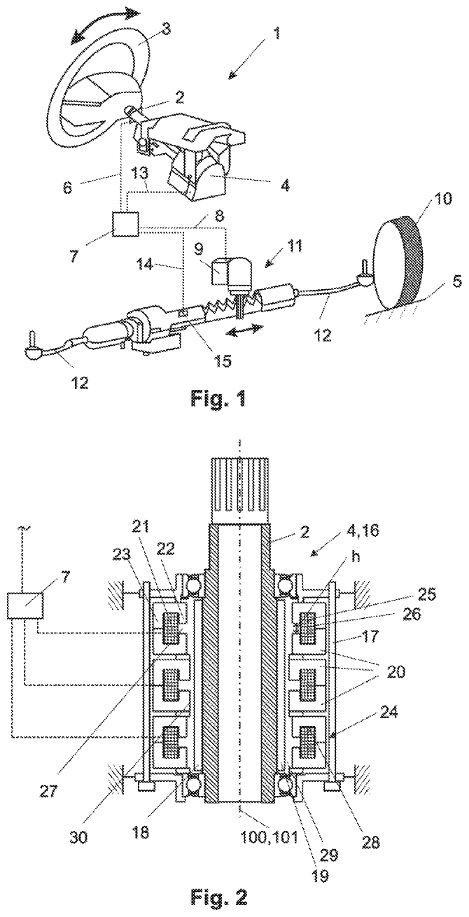

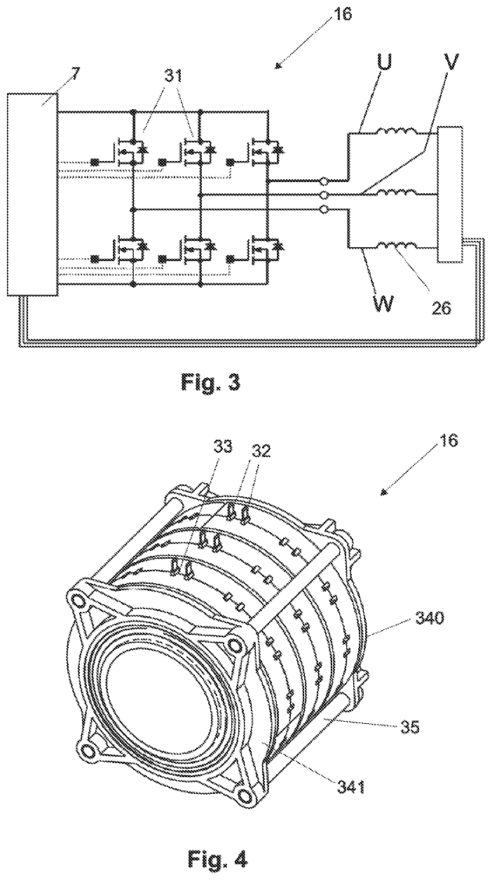

FIG. 4: shows a spatial view of a reluctance motor according to the invention with three poles,

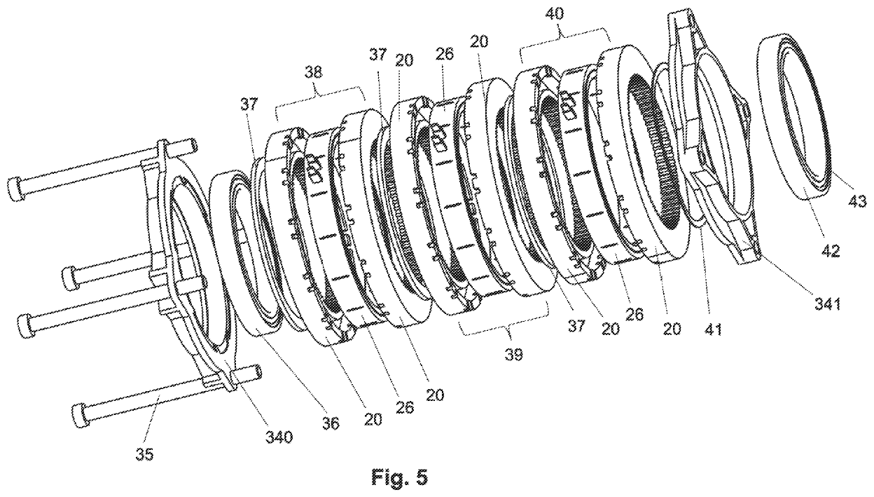

FIG. 5: shows an exploded drawing of the reluctance motor of FIG. 4 without a rotor,

FIG. 6: shows a schematic representation of the reluctance motor in a position with minimal reluctance,

FIG. 7: shows a schematic representation of the reluctance motor in a position with maximal reluctance,

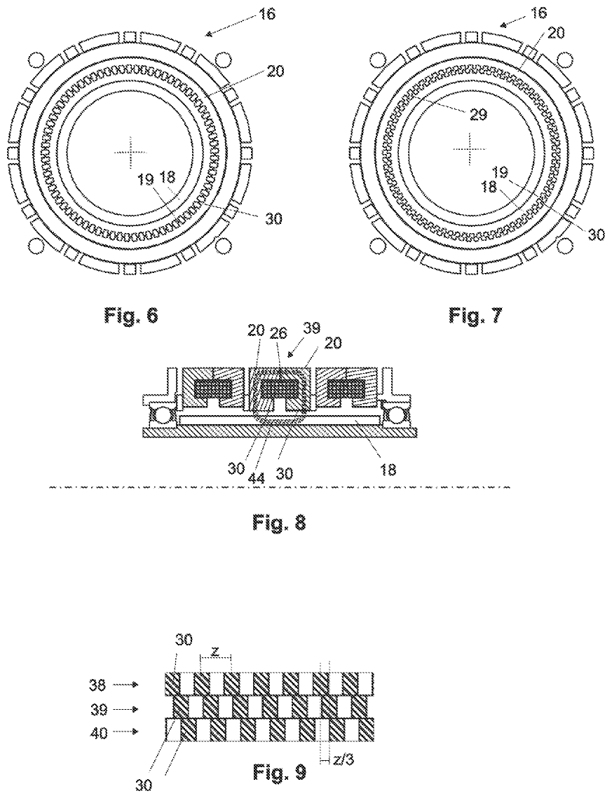

FIG. 8: shows a longitudinal section through the reluctance motor according to the invention of FIG. 2 with plotted magnetic flux,

FIG. 9: shows a schematic representation of the orientation of the tooth elements of the stator segments to one another,

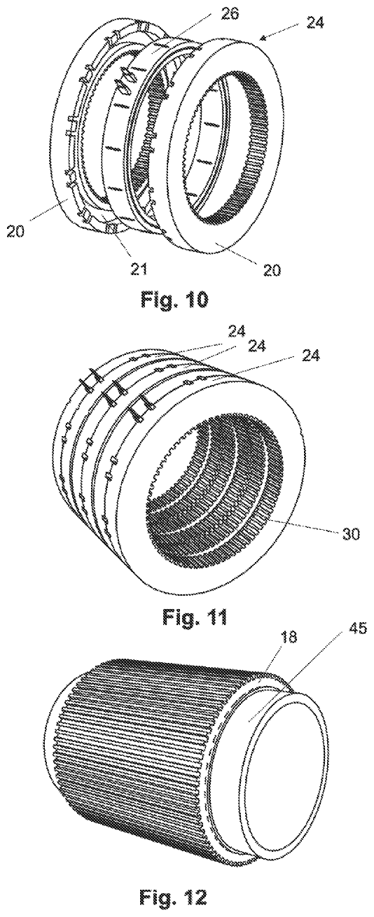

FIG. 10: shows a schematic structure of a stator segment,

FIG. 11: shows a spatial view of an arrangement of three stator segments,

FIG. 12: shows a schematic structure of a rotor,

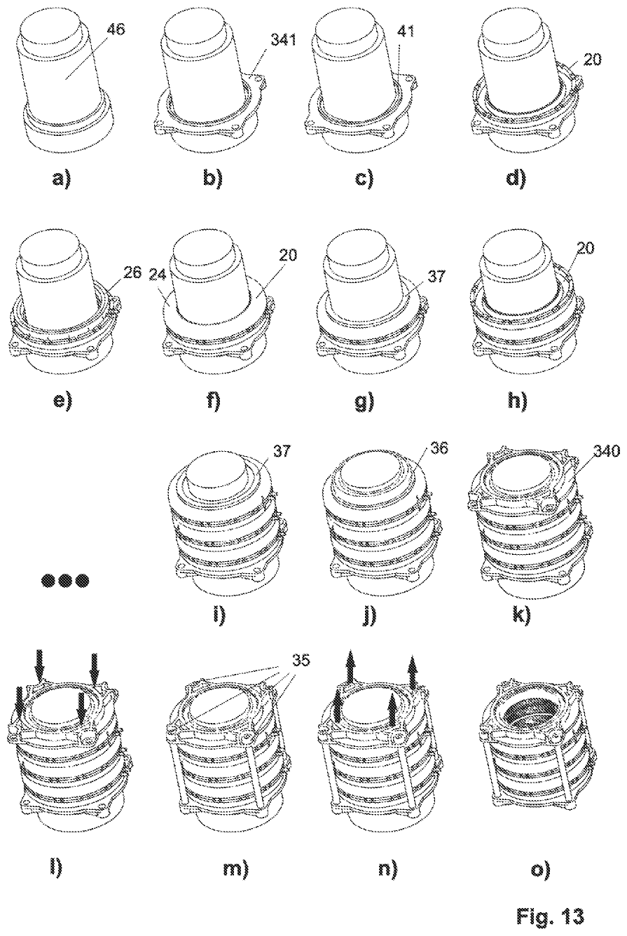

FIGS. 13a-o: show longitudinal sections through the reluctance motor in the sequence of assembly,

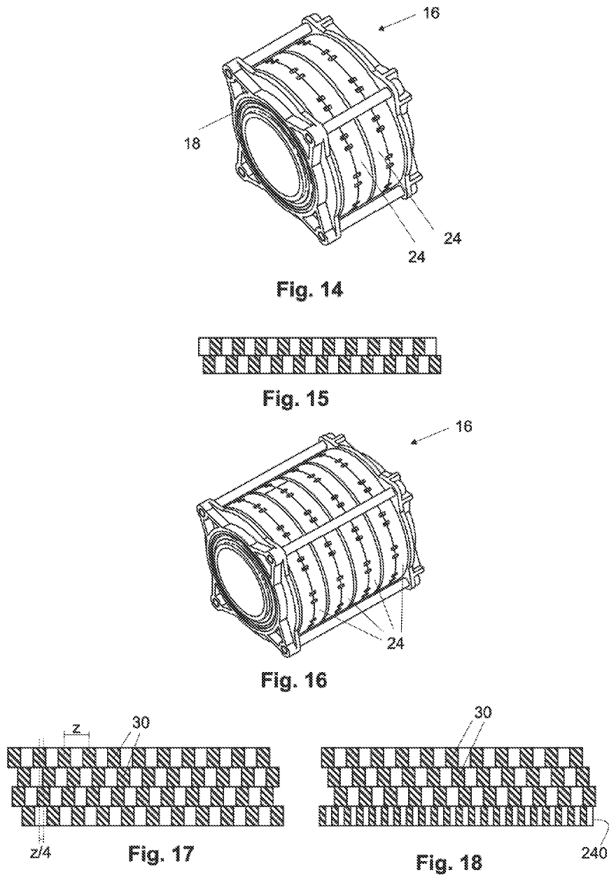

FIG. 14: shows a spatial representation of a reluctance motor with a magnetized rotor and two stator segments,

FIG. 15: shows a schematic representation of the orientation of the tooth elements of the stator segments of the reluctance motor represented in FIG. 14 to one another,

FIG. 16: shows a spatial representation of a reluctance motor with a magnetized rotor and four stator segments,

FIG. 17: shows a schematic representation of a possible orientation of the tooth elements of the stator segments of the reluctance motor represented in FIG. 16 to one another,

FIG. 18: shows a schematic representation of a possible orientation of the tooth elements of the stator segments of the reluctance motor represented in FIG. 16 to one another with a reluctance brake,

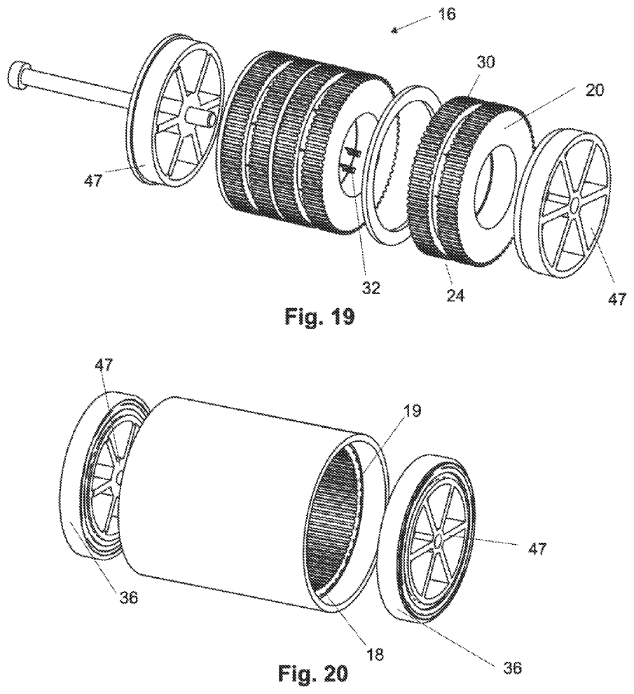

FIG. 19: shows an exploded drawing of a reluctance motor without an external rotor,

FIG. 20: shows a spatial representation of the external rotor of the reluctance motor of FIG. 19,

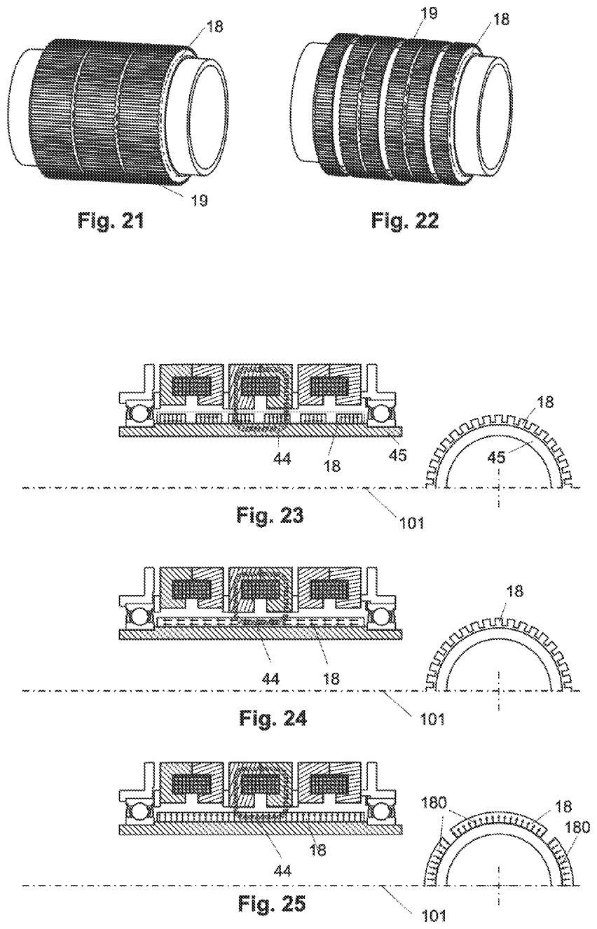

FIGS. 21,22: show spatial representations of a rotor with a multi-part rotor rim,

FIG. 23: shows a longitudinal section through a reluctance motor with a magnetized rotor,

FIG. 24: shows a longitudinal section through a further reluctance motor with a magnetized rotor,

FIG. 25: shows a longitudinal section through a reluctance motor with a magnetized rotor having four segments,

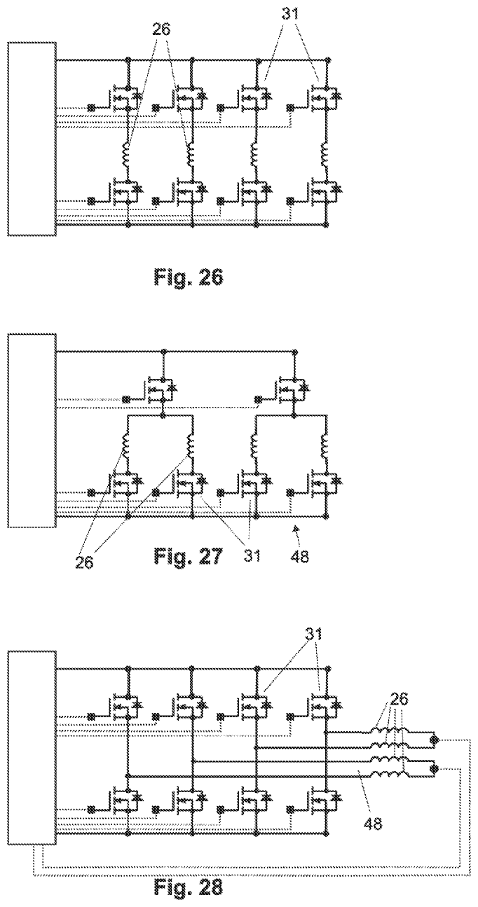

FIG. 26: shows a spatial representation of a circuit of a four-phase reluctance motor,

FIG. 27: shows a schematic representation of a further circuit of a four-phase reluctance motor,

FIG. 28: shows a schematic representation of a circuit of a four-phase reluctance motor with magnets, as well as

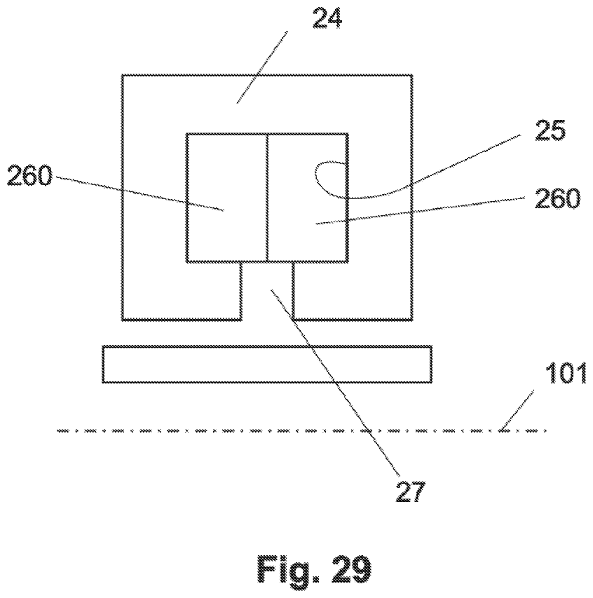

FIG. 29: shows a schematic longitudinal section through a stator segment with two coil segments.

A steer-by-wire steering system 1 is shown in FIG. 1. A rotational angle sensor, not represented, is attached to a steering shaft 2, which rotational angle sensor detects the driver steering angle applied by rotating a steering input means 3, which is formed in the example as a steering wheel. A steering torque can, however, additionally or alternatively also be detected. A feedback actuator 4 is furthermore fitted on steering shaft 2, which feedback actuator 4 serves to simulate the feedback effects from carriageway 5 to steering wheel 3 and thus provide the driver with feedback about the steering and driving characteristics of the vehicle. The driver's steering desire is transmitted via the rotational angle of steering shaft 2 measured by the rotational angle sensor via a signal line 6 to a control unit 7. Control unit 7 transmits the driver's steering desire via a signal line 8 to an electric steering adjuster 9 which controls the position of steered wheels 10. Steering adjuster 9 acts via a steering rod steering gear 11, such as, for example, a toothed rod steering gear, as well as via tie rods 12 and other components indirectly on steered wheels 10. Control unit 7 preferably also takes on the actuation of feedback actuator 4 via a signal line 13. Control unit 7 furthermore receives via a signal line 14 signals from sensors 15 from steering gear 11.

A feedback actuator 4 with a reluctance motor 16 according to the invention is represented in FIG. 2. The term reluctance motor refers in the wider sense to motors, in the case of which a variable magnetic field is generated by a stator, and the rotor normally has poles without windings composed of ferromagnetic material, the rotor in the magnetic field striving to align according to a position of minimal reluctance. The alignment of the magnetic field in the stator can be changed step-by-step or continuously in relation to the center of rotation of the rotor so that the rotor moves either correspondingly by a discrete angle magnitude or continuously.

Steering shaft 2 has at one end a receiver for fastening steering shaft 2 to the steering wheel, not represented. Steering shaft 2 is formed to be hollow. Steering shaft 2 is mounted rotatably in housing 17 at the end close to the steering wheel and at the end distant from the steering wheel. Housing 17 surrounds feedback actuator 4 which concentrically surrounds steering shaft 2. Feedback actuator 4 has reluctance motor 16, rotor 18 of which is connected in a rotationally conjoint manner to steering shaft 2. Rotor 18 lies with its inner side directly on the outside of steering shaft 2. Rotor 18 has, on the outside, teeth 19 which extend at the same distance parallel to one another along the longitudinal axis of rotor 100. The longitudinal axis of rotor 100 corresponds to the longitudinal axis of steering shaft 101. Teeth 19 extend over the length of reluctance motor 16 without interruption. Rotor 18 is surrounded by a total of six stator rings 20 which lie in succession and which have in each case a U-shaped profile with a circumferential annular groove 21 and two limbs 22,23. Limbs 22,23 of the stator rings extend here in the direction of longitudinal axis 100 of rotor 18 and are arranged concentrically to it. Two stator rings 20 form a stator segment 24. The two stator rings 20 of a stator segment 24 are aligned with one another so that the two circumferential annular grooves 21 point into the center between the two stator rings 20 and form a cavity 25 for a toroidal coil 26. The limbs of a stator ring 22,23 are of different lengths, shorter limb 22 being the limb close to the rotor. The two stator rings 22,23 of a stator segment thus lie against the front sides of longer limbs 23 and an air gap 27 is formed between the front sides of shorter limbs 22. Air gap 27 is smaller than the extent of toroidal coil 26 in the direction of longitudinal axis 100. Air gap 27 is formed to be circular-cylindrical with a constant height h in the direction of longitudinal axis 100 and aligned concentrically to longitudinal axis 100.

An air gap 28 can be generated between toroidal coil 26 and stator segment 24, which air gap 28 negatively influences thermal discharge. A heat-conducting paste or adhesive can therefore be provided in air gap 28, which facilitates thermal discharge.

The windings of toroidal coils 26 run in the circumferential direction about longitudinal axis 101 of steering shaft 2. An air gap 29 is provided between rotor 18 and stator segments 24 so that rotor 18 can rotate with steering shaft 2, while stator segment 24 is held in a stationary manner on housing 17. Stator rings 20 have, on the inside or on the outside of limb 22 close to the rotor, teeth 30 which correspond to rotor 18. These teeth 30 are represented in FIG. 2 for the central stator segment.

Two stator rings 20 and a coil 26 are provided for each phase. Reluctance motor 16 represented in FIG. 2 has a total of three phases.

Control unit 7 is connected to feedback actuator 4 and controls the energization of the windings of toroidal coils 26. Toroidal coils 26 can be energized to a different extent with pulse width modulation (PWM). As a result of this, the force action of each coil can be adjusted. The total force on rotor 18 is produced from the superimpositioning of all force vectors. As a result of this, for example, the torque ripple of reluctance motor 16 can be compensated for. In contrast, it is also possible to build in a deliberate torque ripple, in particular as a haptic feedback transmitter. The adjustable energization is preferably performed from a direct voltage source by pulse width modulation using an inverter, not represented. The interconnection of the coils can be dependent (e.g. star point circuit) or independent (individual actuation).

FIG. 3 shows schematically the actuation of the three phases U,V,W of reluctance motor 16 by control unit 7. A total of six semiconductor switches 31, for example, IGBT, are provided in order to actuate the three phases U,V,W. The interconnection of coils 26 can be dependent on one another (e.g. start point circuit) or independent of one another (individual actuation). Depending on the interconnection of the phases U,V,W, a return line to the control unit can be provided. Toroidal coils 26 can be actuated by semiconductor switches 31 in such a manner that a rotating magnetic field is generated in the stator and as a result the rotor undergoes rotation by virtue of the fact that it continuously seeks to reach a position of minimal reluctance.

Reluctance motor 16 is shown in a spatial representation in FIG. 4. Ports 32 for toroidal coils 26 of the three phases can be seen which are arranged between two stator rings 20 of a phase and penetrate through these and thus protrude beyond the outside of stator rings 20. External, longer limb 23 of stator rings 20 has recesses 33 for this purpose. Stator segments 24 are preferably secured via front plates 340,341 in an axial interference fit assembly. Front plates 34 are connected to one another by means of connecting screws 35. The control unit which has an inverter is preferably fastened on and/or in one of the front plates. The front plate and housing of the inverter are particularly preferably formed integrally/in one piece. An angle position sensor can be fitted on the front side on a shaft end. The associated measuring apparatus is preferably accommodated in one of the front plates.

FIG. 5 shows a detailed view of the individual motor elements without a rotor. As seen from left to right along longitudinal axis 100, a first front plate 340 is provided which forms a seat for a floating bearing 36. Floating bearing 36 is preferably a grooved ball bearing. A spacer 37 is provided between first front plate 340 and floating bearing 36 and a first stator ring 20. First stator ring 20, a first toroidal coil 26 and a second stator ring 20 form first phase 38. First phase 38 is followed by a second phase 39 with a third and fourth stator ring 20 and a second toroidal coil 26 arranged therebetween. Phases 38,39 are spaced apart from one another by a spacer 37. This is followed by a third phase 40 spaced apart via a spacer 37, which third phase 40 has a fifth and sixth stator ring 20 with a third toroidal coil 26 arranged therebetween. Sixth stator ring 20 lies against second front plate 34 and is supported via a corrugated spring 41 on an outer ring 42 of a fixed bearing 43. Fixed bearing 43 sits in second front plate 341. Fixed bearing 43 is preferably a grooved ball bearing which can have reduced axial clearance. Corrugated spring 41 is preferably formed from spring steel. Connecting screws 35 penetrate through first front plate 340 and are supported thereon. They are screwed into a thread in second front plate 341. Connecting screws 35 are preferably produced from steel and can also have adhesive screw locking. A special flank geometry of the screw drive can furthermore be provided which only allows a screwing in of the screw. Front plates 340,341 are preferably formed from aluminum and are preferably produced by pressure casting with machining finishing. Spacers 37 are arranged between stator rings 20 of individual phases 38,39,40 in order to reduce mutual magnetic influence and improve cooling. Spacers 37 are preferably produced from aluminum sheet or another low-magnetic steel.

FIGS. 6 and 7 show two positions of a stator segment 20 of reluctance motor 16. In FIG. 6, the air gap between rotor 18 and stator segment 20 is as small as possible and thus the reluctance is minimal. The teeth of rotor 19 and of stator 30 lie opposite one another. In contrast, in the position of FIG. 7, the reluctance is maximal. The teeth of rotor 19 are arranged offset from the teeth of stator 30 by a half tooth distance.

Magnetic flux 44 in middle phase 39 is represented in FIG. 8. An electric current flows through toroidal coil 26 in the direction of the current, which electric current generates a magnetic field. Third and fourth stator ring 20 of the middle stator segment conduct generated magnetic flux 44 of the magnetic field from the pole teeth of the third stator ring to the pole teeth of the fourth stator ring of opposite polarity. The pole teeth of the two stator rings are arranged flush on the same line, parallel to the longitudinal axis, successively, with an air gap between the pole teeth. The magnetic field penetrates through the air gap between stator and rotor and magnetic flux 44 runs through the tooth of rotor 18. Since the teeth of stator segment 30 and of rotor 18 lie opposite one another, the reluctance for the middle stator segment is minimal.

The position of the teeth of stator segments 30 in the circumferential direction about the axis of rotation for the three phases 38,39,40 is represented in FIG. 9. The teeth of the three stator segments have an identical tooth distance Z, corresponding to a distance angle. The teeth of individual stator segments 30 are displaced relative to one another by in each case a distance Z/3 in the direction of rotation. In the case of active excitation winding of first phase 38, the rotor strives to reach a position of minimal reluctance, i.e. a position with as small as possible an air gap between the pole teeth of the rotors and the pole teeth of the first stator segment. The position of minimal reluctance in the case of active excitation winding of second phase 39 is correspondingly displaced by Z/3 in the direction of rotation, or in the case of active excitation winding of third phase 40 by ⅔*Z in the direction of rotation. The rotor can thus be caused to rotate by targeted energization of individual phases 38,39,40.

FIG. 10 shows an individual phase 38,39,40 with stator segment 24 and toroidal coil 26 in detail. Toroidal coils 26 are produced by winding the windings. The windings are cast in with an integrated connector which forms ports 32 in an injection molding process. It can also be provided that, instead of one coil segment 26, two coil segments can be inserted and the protruding connector elements connected in series. Prewound toroidal coil 26 can be form-pressed prior to insertion into annular groove 21 of stator ring 20. The degree of filling of conductive material in annular groove 20 can thus be increased. Toroidal coil 26 can also be pressed inside an annular groove 20. This increases the degree of filling in the same manner.

The windings of toroidal coil 26 are preferably formed from copper or aluminum wire and preferably overmolded with duroplastic or thermoplastic.

Stator rings 20 are produced by powder technology, sintering processes or injection molding. They can be formed from sintered soft-magnetic materials or non-sintered soft-magnetic materials (SMC).

The orientation of teeth 30 of stator segments 24 is represented in FIG. 11. The tooth pairs of a stator segment 24 are arranged in an axially flush manner and have no offset. It can, however, also be provided to offset individual gear rims of a stator segment from one another, e.g. by ½, ¼ or ⅓ of tooth distance Z. The number of teeth along the circumference is preferably greater than 30, preferably greater than 50.

FIG. 12 shows in detail rotor 18 arranged on a hollow shaft 45. Rotor 18 can, however, also sit directly on a steering shaft. The rotor can be composed of a soft-magnetic, non-magnetized material. In FIG. 12, rotor 18 is a permanent magnet, preferably a high-performance permanent magnet which is produced, for example, from NdFeB (neodymium-iron-boron), SmCo (samarium-cobalt), AlNiCo (aluminum-nickel-cobalt), hard ferrites or the like. The rotor can be hot-pressed, thermally deformed or sintered.

FIGS. 13a)-o) show an assembly method of reluctance motor 16. An assembly pin 46 is provided which ensure the relative alignment of stator segments 24 to one another (angle position). Assembly pin 46 has six stator pins, not represented, which can be jointly retracted and extended via a mechanism. The stator pins engage into the toothing of stator segments 24. As a result of this, the risk of unintentional rotation of the gear rims of stator segments 24 during the assembly process is inhibited. In a first step represented in FIG. 13b), second front plate 341 is placed onto a seat onto assembly pin 46. This is followed by insertion of corrugated spring 41 before the stator pins are extended. Thereafter, sixth stator ring 20 is placed on assembly pin 46, followed by third toroidal coil 26 and fifth stator ring 20. A spacer 37 separates fifth stator ring 20 from fourth stator ring 20 which is laid on spacer 37. Thereafter, second toroidal coil 26, third stator ring 20, a further spacer 37, second stator ring 20, first toroidal coil 26 and first stator ring 20 are put in place in turn on assembly pin 46. Next, a spacer 37 is placed onto which fixed bearing 36 is laid. Finally, first front plate 340 which has a seat for fixed bearing 36 is subsequently put in place. A pretensioning is generated by pressure on first front plate 340. This pretensioning is preferably approximately 50 kN. The two front plates 340,341 are then fastened to one another by means of connecting screws 35. Connecting screws 35 are tightened to a torque of approximately 2 Nm. After tightening of screws 35, the pretensioning is removed, the stator pins are retracted and assembly pin 46 is removed.

This assembly process is particularly simple and is highly suitable as a result of the small number of tools required, an assembly pin 46 and a screwdriver.

A reluctance motor 16 with a magnetized rotor 18 is represented in FIG. 14. Reluctance motor 16 has only two stator segments 24 which according to FIG. 15 are arranged offset to one another in the circumferential direction. In the case of a reluctance motor 16 with 2-phase control, the coil-free body, in particular the gear rim is preferably magnetized or has permanent magnets. As a result of the magnetization, Lorentz forces are superimposed on reluctance forces. Lorentz forces are dependent on the direction of flow of the magnetic field. The clarity of the rotation thus emerges as a result of the direction of the coil current. The advantage of this arrangement is that only two stator segments are used, which leads to greater magnetic flux and higher forces. It is, however, disadvantageous that torque ripple is also present in the switched-off state.

FIG. 16 shows a reluctance motor 16 with four stator segments 24. The tooth distribution of the segments which belong to the phases can be performed, for example, according to FIG. 17 or FIG. 18. The offset in FIG. 17 is Z/4 and thus finer than in the 3-segment variant. The sequence of the stator segments in the longitudinal direction is fundamentally not important. FIG. 18 shows a stator segment 240 with a higher number of teeth in the circumferential direction. This stator segment can serve as a reluctance brake. In this case, the first three segments, in an analogous manner to FIG. 2, take on the motor function and fourth segment 240 serves solely as a holding brake for blocking a rotational movement, for example, for a variable end stop. The first three segments and fourth segment 240 are preferably actuated by two different control units.

FIGS. 19, 20 show a variant of reluctance motor 16 as an external rotor. Toothing 30 of stator rings 20 is located on the outside and ports 32 on the inside. Rotor 18 surrounds stator segments 24 and has, as represented in FIG. 20, on the inside toothing 19. Mounting of rotor 18 (external rotor) is performed via two ball bearings 46 via front plates 47.

FIGS. 21,22 show different embodiments of a multi-part rotor 18. Toothing 19 of rotor 18 is subdivided in the longitudinal direction. This opens up the possibility that the rotation of the tooth flanks cannot occur in the stator, but rather in the rotor. It is also conceivable that the tooth flanks of the rotor are not embodied to have parallel rotational axes as represented here, rather are skewed and the rotor is a “skewed rotor”. This has the advantage that the teeth of the stator segments do not have to be rotated against one another, but at the same time the rotor can be manufactured with only one continuous gear rim.

FIGS. 23-25 show embodiments with magnetized rotor 18. Individual magnets or multi-magnetized magnets (one-piece magnet with differently magnetized regions) can be used.

FIG. 23 shows a magnetized and multi-part rotor 18 with alternating magnetization in the radial direction along longitudinal axis 100. Magnetic flux 44 runs through stator segment 24, rotor 18 and hollow shaft 45.

The magnetization of rotor 18 in the axial direction is provided in FIG. 24. Magnetic flux 44 therefore runs through rotor 18 in the direction of magnetization.

FIG. 25 shows a rotor 18 with four rotor segments 180 which are formed in the circumferential direction and which are magnetized alternately radially outward and inward. The distance between rotor segments 180 does not correspond to a multiple of the tooth pitch of the stator, but rather is displaced, e.g. by half a tooth.

Three circuits for a reluctance motor with four toroidal coils 26 are represented in FIGS. 26 to 28.

FIG. 26 shows a circuit for a reluctance motor without magnets. Coils 26 are clamped parallel between plus and minus pole. Each phase possesses two semi-conductor components 31. Toroidal coils 26 lie in the half bridges. Thus, in the case of a defect of a phase, it can be shut down in a targeted manner without having to switch off the entire motor.

FIG. 27 also shows a circuit for a reluctance motor without magnets. Two phases are combined to form a phase pair so that the safety shutdown is reduced to two phase pairs 48 (2×2 circuit). In the case of a defect of a phase, the motor can no longer be operated as a motor. In the case of shutdown of a phase pair 48, the motor can, however, still be operated as a brake. As a result, two switches 31 can be omitted.

FIG. 28 shows a 2×2 circuit for a four-phase reluctance motor with magnets. In each case two toroidal coils 26 are connected in series and connected to two half-bridges. Two switches 31 are required for each branch in order to be able to specify the direction of electric current. In the case of a failure of a phase or a phase pair 48, the motor can be operated further with only one phase pair 48.

FIG. 29 shows a schematic longitudinal section through a stator segment 24 with two toroidal coil segments 260. Toroidal coil segments 260 are arranged in rows next to one another in longitudinal direction 100. Stator segment 24 is formed in one piece and has cavity 25 described above for toroidal coil segments 260 and air gap 27.

The reluctance motor according to the invention has a modular structure. It can be expanded by any desired number of segments. In the simplest case, the further segments have an identical structure so that a motor with double output can be composed of twice as many modules which are actuated in an identical manner. It is, however, also possible to change the tooth pitch of the individual modules so that a more precise graduation of the motor is present (with a torque which is constant as before if at all times only one coil is energized). Both principles can be combined.

The reluctance motor is preferably used in a steering system. Particularly preferably in a steer-by-wire steering system. It can serve as a feedback actuator. It can simultaneously also serve as a variable end stop. Alternatively, the reluctance motor can be extended by a further, independent stator segment which serves as a variable steering stop (combination of reluctance motor and reluctance brake). The reluctance motor can furthermore be used as steering force assistance for a steering gear, where, due to the higher torque, transmission stages or a transmission itself can be dispensed with.

The tooth shape of the toothing of the rotor and the stator rings is not restricted to the represented shape. It can have an undulating form, be pointed or flat, have a mixed form of these types or another special form.

1.-31. (canceled)

32. A reluctance motor comprises:
a rotor that is configured to rotate about a longitudinal axis; and
a stator;
wherein the rotor has on a surface adjacent to the stator a toothing, and the stator has on a surface adjacent to the rotor a corresponding toothing, the teeth of which extend in the direction of the longitudinal axis;
wherein the stator has at least two cavities arranged successively in the longitudinal direction, each of the at least two cavities configured to receive a toroidal coil configured to be energized, windings of the toroidal coils being wound concentrically around the longitudinal axis;
wherein the stator is penetrated on the side adjacent to the rotor for the formation of a respective air gap toward the cavities; and
wherein the air gap is aligned in a circular-cylindrical manner and concentrically to the longitudinal axis and has a constant height in the direction of the longitudinal axis which is smaller than an extent of the toroidal coil in the direction of the longitudinal axis.

33. The reluctance motor of claim 32 wherein the surface of the stator close to the rotor has grooves which form the toothing.

34. The reluctance motor of claim 32 wherein the stator has stator segments, each stator segment surrounding a respective toroidal coil and formed from two or three components.

35. The reluctance motor of claim 33 wherein the stator segments are formed from two components, the components being stator rings between which the respective toroidal coil is received.

36. The reluctance motor of claim 34 wherein the stator rings have in each case a U-shaped profile with a circumferential annular groove and two limbs, the limbs of the stator rings extending in the direction of the longitudinal axis and being arranged concentrically thereto.

37. The reluctance motor of claim 35 wherein the two stator rings of a stator segment are aligned to one another so that the two circumferential annular grooves point into the center between the two stator rings and form the cavity for the toroidal coil.

38. The reluctance motor of claim 35 wherein the limbs of the stator rings are of different lengths, the stator rings lying against the front sides of the longer limbs and the air gap being formed between the front sides of the shorter limbs.

39. The reluctance motor of claim 32 wherein the rotor has magnets on the surface close to the stator.

40. The reluctance motor of claim 32 wherein the teeth of the rotor extend in the direction of the longitudinal axis.

41. The reluctance motor of claim 32 wherein a heat-conducting paste or heat-conducting adhesive is incorporated in the cavity between toroidal coil and stator.

42. The reluctance motor of claim 32 wherein the windings of the toroidal coils are surrounded by a polymer.

43. The reluctance motor of claim 42 wherein a connector of a port is integrated in the polymer.

44. The reluctance motor of claim 32 wherein the rotor is arranged exclusively inside or outside the stator.

45. The reluctance motor of claim 32 wherein the toroidal coil has two coil segments connected in series.

46. The reluctance motor of claim 32 wherein the toroidal coil is a separate pre-assembled component.

47. The reluctance motor of claim 32 wherein the reluctance motor has a control unit, the toroidal coils being actuable by means of the control unit with pulse width modulation.

48. The reluctance motor or claim 47 wherein the control unit has an inverter for energizing the toroidal coils.

49. The reluctance motor of claim 34 wherein the stator segments are secured via front plates in an axial interference fit assembly.

50. The reluctance motor of claim 47 wherein the control unit is fastened on and/or in one of the front plates.

51. The reluctance motor of claim 50 wherein the front plate and a house of the inverter are formed in one piece.

52. The reluctance motor of claim 32 wherein the toothing of the rotor and of the stator are produced using the sintering process.

53. The reluctance motor of claim 34 wherein the teeth of two stator rings of a stator segment are axially flush.

54. The reluctance motor of claim 32 wherein the number of teeth in the circumferential direction is greater than 50.

55. The reluctance motor as claimed in any one of the preceding claim 32, characterized in that a further, independent stator segment is provided which serves as a reluctance brake.

56. A steer-by-wire steering system for a motor vehicle comprising the reluctance motor of claim 32 and further comprising a steering adjuster which acts on steered wheels of the motor vehicle and is electronically regulated as a function of a driver's steering desire, said steering adjuster acting via a steering gear on the steered wheels, and a feedback actuator which transmits feedback effects to a steering shaft connected to the steering wheel.

57. A steering system for motor vehicles comprising the reluctance motor of claim 32 configured as a direct drive.

58. A method for assembling a reluctance motor comprising:
a rotor which rotates about a longitudinal axis; and
an individual stator;
wherein the rotor has on a surface adjacent to the stator a toothing, and the stator has on a surface adjacent to the rotor a corresponding toothing, the teeth of which extend in the direction of the longitudinal axis;
wherein the stator has at least two cavities arranged successively in the longitudinal direction for receiving in each case a toroidal coil which are configured to be energized, windings of the toroidal coils being wound concentrically around the longitudinal axis;
wherein the stator is penetrated on the side adjacent to the rotor for the formation of a respective air gap toward the cavities;
wherein the stator has stator segments which surround in each case a toroidal coil and which are formed from two or three components; and
wherein the air gap is aligned in a circular-cylindrical manner and concentrically to the longitudinal axis and has a constant height in the direction of the longitudinal axis which is smaller than an extent of the toroidal coil in the direction of the longitudinal axis;
the method comprising:
providing an assembly pin which extends in the longitudinal direction and which ensures the relative alignment of the stator segments to one another,
placing a second front plate on a seat of the assembly pin,
placing the stator segments with toroidal coils arranged therebetween successively on the assembly pin, and
positioning a first front plate onto the last applied stator segment and connecting the two front plates by means of connecting screws.

59. The method claim 58 wherein spacers are positioned between the stator segments onto the assembly pin.

60. The method of claim 58 further comprising:
positioning a corrugated spring onto the second front plate onto the assembly pin, and
extending stator pins connected to the assembly pin.

61. The method of claim 58 further comprising:
placing a spacer onto the last applied stator ring and positioning a rolling bearing which sits in the first front plate.

62. The method of claim 58 further comprising:
generating a pretensioning on the first front plate before the two front plates are connected by means of connecting screws, and
releasing the pretensioning and removing the assembly pin.
